(19) United States
(12) Patent Application Publication
(10) Pub. No.: US 2018/0121974 A1
(43) Pub. Date: May 3, 2018

(54) Automatic Account-On-File Management System And Methods

(71) Applicant: MASTERCARD INTERNATIONAL INCORPORATED, Purchase, NY (US)

(72) Inventors: Michelle L. Hafner, Chesterfield, MO (US); Sharon Amy Rosano, New Canaan, CT (US); John D. Chisholm, Ballwin, MO (US)

(21) Appl. No.: 15/796,029

(22) Filed: Oct. 27, 2017

Related U.S. Application Data
(60) Provisional application No. 62/415,307, filed on Oct. 31, 2016.

(51) Int. Cl. G06Q 30/04; G06Q 20/40

(52) U.S. Cl. CPC G06Q 30/04; G06Q 20/4016

(57) ABSTRACT

A system for automatic account-on-file management may include a resource provider including an account updater and a provider communications interface. The resource provider may store billing information identifying at least one source having an automatic remittance and/or account-on-file for a resource associated with a procurement entity. The account updater may be configured to transmit a source list response indicating each source identified within the billing information. The provider communications interface may be configured to transmit the billing information to a procurement entity device for presentation of each source indicated in the source list response to the procurement entity.

### RELATED APPLICATIONS

This application claims priority to U.S. Provisional Application Ser. No. 62/415,307, filed Oct. 31, 2016 and which is incorporated by reference in its entirety herein.

### BACKGROUND

Automatic remittance systems may allow a procurement entity to make automatic remittance to specific sources (e.g. a utility, store, or other goods or services provider). For example, an automatic remittance system may allow a procurement entity to automatically make a utility remittance (e.g. water, electric, gas, etc.) without having to contact the utility provider each month. Moreover, for various sources, the procurement entity may store their card or account information with the utility provider, which is known as an “account-on-file.”

### SUMMARY

Embodiments disclosed herein resolve the technical problem of tracking automatic remittance or account-on-file information. Electronic data management, such as automatic remittance and account-on-file information is subject to technical problem of inconsistent records occurring if one piece of data changes. For example, for an automatic remittance, if the remittance account changes automatically, such as due to actual or potentially fraudulent activity, the automatic remittance arrangement no longer exists because it is based on expired or out-of-date data. Embodiments herein provide a technical solution to this problem by automatic indication to the associated entities that the data has changed. As such, the associated entities are capable of maintaining up-to-date automatic remittance or account-on-file arrangements thereby eliminating potential lack of remittance situations due to expired information.

In an aspect of the embodiments, a system for automatic account-on-file management comprises a resource provider including an account updater and a provider communications interface, the resource provider storing billing information identifying at least one source having an automatic remittance and/or account-on-file for a resource associated with a procurement entity. In embodiments, the account updater is configured to transmit a source list response indicating each source identified within the billing information. In embodiments, the provider communications interface is configured to transmit the billing information to a procurement entity device for presentation of each source indicated in the source list response to the procurement entity.

In another aspect of the embodiments, a method for automatic account-on-file management comprises maintaining a source list identifying billing information associated with at least one source having an automatic remittance and/or account-on-file for a resource associated with a procurement entity. In embodiments, the method further comprises transmitting the source list to a procurement entity device for presentation on the procurement entity device of each source indicated in the source list.

In another aspect of the embodiments, a method for automatic account-on-file management comprises receiving a source list at a procurement entity device, the source list identifying billing information associated with at least one source having an automatic remittance and/or account-on-file for a resource associated with a procurement entity. In embodiments the method further comprises interacting with a procurement entity via the procurement entity device to receive a modification to the source list. In embodiments the method further comprises transmitting a modification indication including the modifications to an account manager.

### BRIEF DESCRIPTION OF THE FIGURES

FIG. 1 depicts a system for automatic account-on-file management, in embodiments.

FIG. 2 depicts a method for automatic account-on-file management, in embodiments.

FIG. 3 depicts another method for automatic account-on-file management, in embodiments.

### DETAILED DESCRIPTION OF THE EMBODIMENTS

When a resource is reissued, or a procurement entity account changes, the procurement entity (e.g., a person, customer, card holder, company, or other entity) is responsible for updating sources (e.g. goods or services providers such as stores, utilities, etc.) with this new information, particularly when the procurement entity has an account-on-file or automatic remittance set up with the source. However, many procurement entities expect their resource issuers or procurement entity account managers to handle updating this information for them. Updating account information is inconvenient and frustrating for procurement entities because updating their information with each source takes time, and procurement entities often neglect to do this. Since the source uses the account-on-file to automatically request and receive remittance, the procurement entity often forgets to update the account-on-file. In addition, where a procurement entity wishes to cancel an automatic remittance or account-on-file, the procurement entity must contact their resource issuer to request a cancellation of the automatic remittance or account-on-file. This results in procurement entity frustration since it takes time for a procurement entity to contact their resource issuer, or account manager, and often leads to future chargebacks.

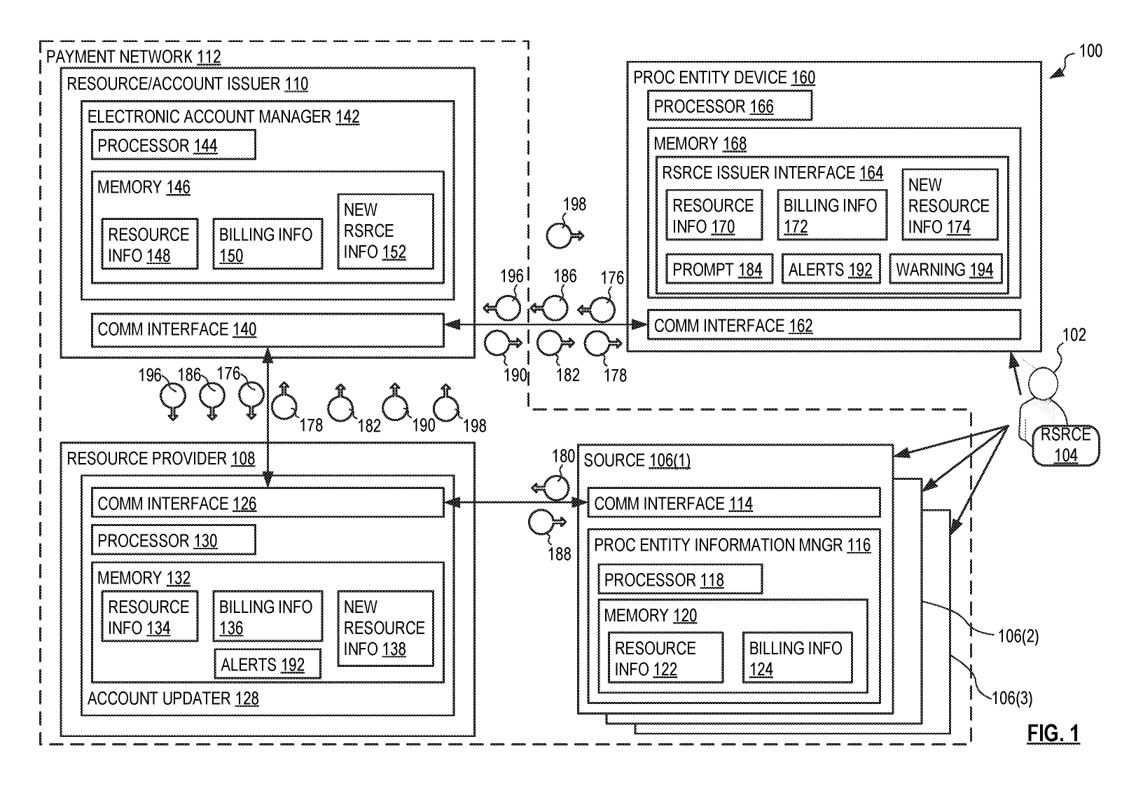

FIG. 1 depicts a system 100 for automatic account-on-file management, in embodiments. System 100 allows procurement entity 102 to seamlessly manage changes made to procurement entity resource 104 (e.g. a credit card, debit card, gift card, bank account, etc.), for example, when fraud is detected in relation to the resource 104. Procurement entity 102 may utilize resource 104 to pay a source 106 for goods or services, e.g. store-bought items, gas, food, utilities, water, electric, etc. In embodiments, resource 104 is used on a recurring basis to pay source 106. Multiple sources 106(1)-106(3) are shown, each indicating an individual source, e.g. a store, a utility, eCommerce site, etc. It should be appreciated that system 100 may apply with multiple procurement entities 102, resource 104 and sources 106.

Resource 104 may be associated with one or both of resource provider 108, and resource/account issuer 110. Resource provider 108 may represent one of: MasterCard®, Visa®, American Express®, and so on, where payment network 112 represents one of the MasterCard® payment network, the Visa® payment network, and the American Express® payment network, respectively. Embodiments shown herein may be used for automatic account-on-file management of four party transactions as handled by MasterCard® and Visa®, and three party transactions as handled by American Express®, for example. Resource 104 need not be a physical card, but may be a unique identifier of a physical card, or may also represent a direct payment from a bank account.

Source 106, as illustrated, represents the actual source (such as a store or utility and server(s) operated thereby) and/or an acquirer server which acts as an intermediary between resource provider 108 and source 106. For example, to initiate a transaction using resource 104, an acquirer may receive an electronic communication from source 106 including an authorization request having information about resource 104 and a sub-total value. Once resource provider 108 has authorized the transaction, a second electronic communication including an authorization approval may be sent from the resource provider 108, via payment network 112 and the acquirer, to the source 106. To complete the transaction a third electronic communication is sent from the source 106 to resource provider 108 via the acquirer and payment network 112. Resource provider 108 may interact with resource/account issuer 110 to validate the information within the authorization request prior to issuing the authorization approval.

Source 106 may include a source communications interface 114, and a procurement entity information manager 116. Source communications interface 114 may be any communication protocol, wired or wireless, that enables communication with resource provider 108. For example, source communications interface 114 may operate on a wired Ethernet connection, a wireless WiFi connection, cellular connection, etc. If necessary, source communications interface 114 may include an application programming interface (API) or software development kit (SDK) to support communications between source 106 and resource provider 108, and such communications may configure to such API or SDK.

For source 106, procurement entity information manager 116 maintains and manages procurement entity information, such as various procurement entity transaction details. Procurement entity information manager 116 may include a processor 118 in communication with memory 120. Memory 120 may store transitory and/or non-transitory computer readable instructions that when executed by the processor 118 enable the functionality of procurement entity information manager 116 discussed herein. Memory 120 may store resource information 122 and billing information 124 for each procurement entity 102. Resource information 122 may include name, address, security ID, and number of resource 104. In embodiments, billing information 124 may include a list of sources that procurement entity 102 has used resource 104 at, and/or has recurring payments set up with. In some embodiments, billing information 124 includes payment amount and payment frequency associated with the resource 104 for the source 106. For example, billing information 124 may indicate that a utility should be paid the 6^{th} day of every month at $180 dollars. Resource information 122 and billing information 124 only provide details of procurement entities 102 that utilize the source 106.

Resource provider 108 may include a provider communications interface 126, and an account updater 128. Provider communications interface 126 may be any communication protocol, wired or wireless, that enables communication with source 106 and/or resource/account issuer 110. Provider communications interface 126 may include a first and a second provider communications interface each respectively enabling communications with source 106 and resource/account issuer 110. For example, provider communications interface 126 may operate on a wired Ethernet connection, a wireless WiFi connection, cellular connection, etc. If necessary, provider communications interface 126 may include an application programming interface (API) or software development kit (SDK) to support communications between resource provider 108 and source 106 and resource/account issuer 110, and such communications may configure to such API or SDK.

Account updater 128 may include a processor 130 in communication with memory 132. Memory 132 stores transitory and/or non-transitory computer readable instructions that when executed by the processor 130 enable the functionality of account updater 128 discussed herein. Memory 132 stores one or more of resource information 134 and billing information 136 for each procurement entity 102 and resource 104 provided by resource/account issuer 110. Resource information 134 includes one or more of name, address, security ID, and resource number of resource 104 associated with each procurement entity 102. Billing information 136 includes payment frequency associated with the resource 104 for each source 106. Memory 132 may further store new resource information 138 received from resource/account issuer 110 and/or procurement entity 102. Resource information 134 and billing information 136 may include information about multiple sources 106 for procurement entity 102, and include such information [for or on] other procurement entities. New resource information 138 may be received and/or automatically generated and is associated with procurement entity 102 such as, for example, when one or more resources (e.g., cards or accounts) expire, and/or potential fraud is detected on one or more resources (e.g., cards or accounts or accounts) identified within resource information 134.

Resource/account issuer 110 may include an issuer communications interface 140, and an electronic account manager 142. Issuer communications interface 140 may be any communication protocol, wired or wireless, that enables communication with resource provider 108 and/or a procurement entity device 160. Issuer communications interface 140 may include first and second provider communications interface, each respectively enabling communications with resource provider 108 and a procurement entity device 160. For example, issuer communications interface 140 may operate on a wired Ethernet connection, a wireless WiFi connection, cellular connection, etc. If necessary, issuer communications interface 140 may include an API or SDK to support communications between resource/account issuer 110 and resource provider 108 and procurement entity device 160, and such communications may configure to such API or SDK.

Electronic account manager 142 may include a processor 144 in communication with memory 146. Memory 146 may store transitory and/or non-transitory computer readable instructions that when executed by the processor 144 enable the functionality of electronic account manager 142 discussed herein. Memory 146 stores one or more of resource information 148, billing information 150, and new resource information 152 for each procurement entity 102 and resource 104 provided by resource provider 108. Resource information 148 may include name, address, security ID, and number of resource 104. Billing information 150 may include payment amount and payment frequency associated with the resource 104 for each given source 106.

Memory 146 may further store new resource information 152, when generated. New resource information 152 may be automatically created, for example, when resource 104 expires, and/or potential fraud is detected on one or more resources identified within resource information 148. In certain embodiments, memory 146 only temporarily stores billing information 150, for example when acting as an intermediary between procurement entity device 160 and resource provider 108. Temporary storage reduces the security risk associated with storing billing information such as payment amounts and frequency associated with each source 106.

Procurement entity device 160 may include a procurement entity device communications interface 162, and a resource issuer interface 164. Procurement entity device communications interface 162 may be any communication protocol, wired or wireless, that enables communication with resource/account issuer 110. For example, procurement entity device communications interface 162 may operate on a wired Ethernet connection, a wireless WiFi connection, cellular connection, etc. If necessary, procurement entity device 160 may include an application programming interface (API) or software development kit (SDK) to support communications between procurement entity device 160 and resource/account issuer 110, and such communications may configure to such API or SDK.

Resource issuer interface 164 provides an interface for procurement entity 102 to interact, via procurement entity device 160, with resource/account issuer 110 to obtain information regarding resource 104. Procurement entity device 160 may include a processor 166 in communication with memory 168. Resource issuer interface 164 may be an interface generated when processor executes transitory and/or non-transitory computer readable instructions stored within memory 168. Resource issuer interface 164 may be an application, web portal, telephonic portal, or other interface that procurement entity 102 interacts with via procurement entity device 160.

Memory 168 stores one or more of resource information 170, billing information 172, and new resource information 174. Resource information 170 may include name, address, security ID, and resource number (e.g. card number or account number) of resource 104 (as well as other resources that procurement entity 102 has issued from resource/account issuer 110). Billing information 172 may include payment amount and payment frequency associated with procurement entity 102 and particularly resource 104 for each given source 106. New resource information 174 may include name, address, security ID, and resource number of a new resource that replaces resource 104 when one or both of resource/account issuer 110 and resource provider 108 determine that resource 104 is expired or has fraudulent activity.

Procurement entity 102 may utilize resource issuer interface 164 to obtain information regarding those sources 106 in which procurement entity 102 has automatic remittances and/or account-on-file set up in association with resource 104. For example, procurement entity 102, via interaction with resource issuer interface 164 may request a list of all sources 106 with automatic payments and/or account-on-file set up in association with resource 104. In turn, a source list request 176 may be transmitted from procurement entity device 160 to resource provider 108, via resource/account issuer 110. Resource provider 108 may query billing information 136 to determine which sources 106 include an automatic payment and/or account-on-file setup, and transmit a source list response 178, via resource/account issuer 110, to procurement entity device 160 for storage within memory 168 and presentation to procurement entity 102 via resource issuer interface 164.

Source 106 may interact with resource provider 108 to identify automatic payments and/or account-on-file by transmitting an on-file indication 180 to resource provider 108 including the resource information 122 and billing information 124 for each resource 104 that is set up for automatic remittance and/or account-on-file in association with the given source 106. In turn, account updater 128 may update billing information 136 based upon billing information 124. In certain embodiments, source list response 178 is generated automatically by account updater 128 in response to receiving on-file indication 180.

In certain embodiments, one or both of resource provider 108 and resource/account issuer 110 may detect fraudulent activity on the procurement entity's account or resource 104, or that the resource is about to or has expired. In such embodiments, resource/account issuer 110 may generate new resource information 152. In embodiments, new resource information 152 may be transmitted to resource provider 108 and stored as new resource information 138. In other embodiments, resource provider 108 generates new resource information 138 in response to a detection of fraudulent activity on the procurement entity's account or resource 104, or when the resource is about to or has expired. One or both of resource provider 108 and resource/account issuer 110 may generate a new resource indication 182 and transmit such indication 182 to procurement entity device 160. New resource indication 182 may include new resource information 152 for storage in memory 168 as new resource information 174. Procurement entity device 160, in response to receiving new resource indication 182, may generate a prompt 184 to procurement entity 102, within resource issuer interface 164, for a request to update billing information. Prompt 184 may include at least one of: the new resource information 174, a list of all sources 106 within billing information 172 in which the procurement entity 102 has automatic remittance and/or account-on-file with, and charge information (as identified within billing information 172) for each associated source 106. Upon receipt of the prompt, procurement entity 102 may select one or more sources 106 in which the procurement entity 102 has automatic remittance or account-on-file set up with to modify the automatic remittance and/or account-on-file status. Such modification may include any one or more of: updating with the new resource information, cancellation of the automatic remittance information and/or account-on-file status with that given source 106, and configuring an alert for a given source 106 (as discussed below).

Upon receiving such modification from procurement entity 102 interacting with resource issuer interface 164, resource issuer interface 164 may generate a modification indication 186 and transmit said modification indication 186 to resource/account issuer 110, and/or resource provider 108 (via resource/account issuer 110). Resource/account issuer 110 and/or resource provider 108 may then update billing information 150 and billing information 136, respectively, with the modifications. For example, in embodiments, billing information 150 and/or billing information 136 may be modified to indicate that a given source 106 should be updated with the new resource information. In such embodiments, resource provider 108 may transmit such new resource information 138 to source 106 as a new resource update 188 and source 106 can replace resource information 122 with new resource information 138 contained within new resource update 188. As another example, in embodiments, billing information 150 and/or billing information 136 may be modified to indicate cancellation of automatic remittance and/or account-on-file with a particular source 106. In such embodiments, resource provider 108 may update billing information 136 indicating that automatic remittance or account-on-file authorization requests from source 106 should be denied. However, in such embodiments, resource provider 108 may not indicate that such modifications to the status of the given source 106 have been made. In other words, the modifications will be concealed to the source 106 such that the source 106 will not know the procurement entity 102 indicated to cancel automatic remittance and/or account-on-file.

In certain embodiments, upon receipt of new resource indication 182, procurement entity device 160 may automatically generate source list request 176 to receive source list response 178 as discussed above to ensure that billing info 172 is fully up-to-date. In certain embodiments, resource provider 108 and/or resource/account issuer 110 may automatically generate source list response 178 when new resource indication 182 is generated.

In embodiments, any time billing information 136 and/or 150 is modified, a confirmation indication 190 may be sent to procurement entity device 160 from one or both of resource provider 108 and resource/account issuer 110 confirming changes have been made to automatic remittance status and/or account-on-file status for given source(s) 106. In response to receipt of confirmation indication 190, prompt 184 (or a newly generated additional prompt) may be presented to procurement entity 102 via resource issuer interface 164 confirming changes made to the billing information 172 regarding resource 104.

In embodiments, procurement entity 102 may interact with resource issuer interface 164 to configure alert settings 192. Alert setting 192 are configured by procurement entity 102, to indicate when a warning 194 is generated. For example, alert settings 192 may indicate to generate a warning 194 when resource 104 is charged by source 106. As another example, alert settings 192 may indicate to generate a warning 194 when resource 104 is charged by source 106 above a given threshold amount. As another example, alert settings 192 may indicate to generate a warning 194 when resource 104 is charged by source 106 above a given threshold amount and/or at a given time other than an automatic billing period. Alert indication 196, including alert settings 192, may be transmitted from procurement entity device 160 for storage within resource provider 108. As such, any time source 106 requests authorization for a charge on resource 104 that is commensurate with one or more settings within alert settings 192, resource provider 108 may generate a warning indication 198 and transmit such warning indication 198 to procurement entity device 160. Upon receipt of warning indication 198, warning 194 is presented to procurement entity 102 via resource issuer interface 164. Warning 194 may be an auditory, textual, visual, tactile, or other warning that indicates one or more of alert settings 194 have been met.

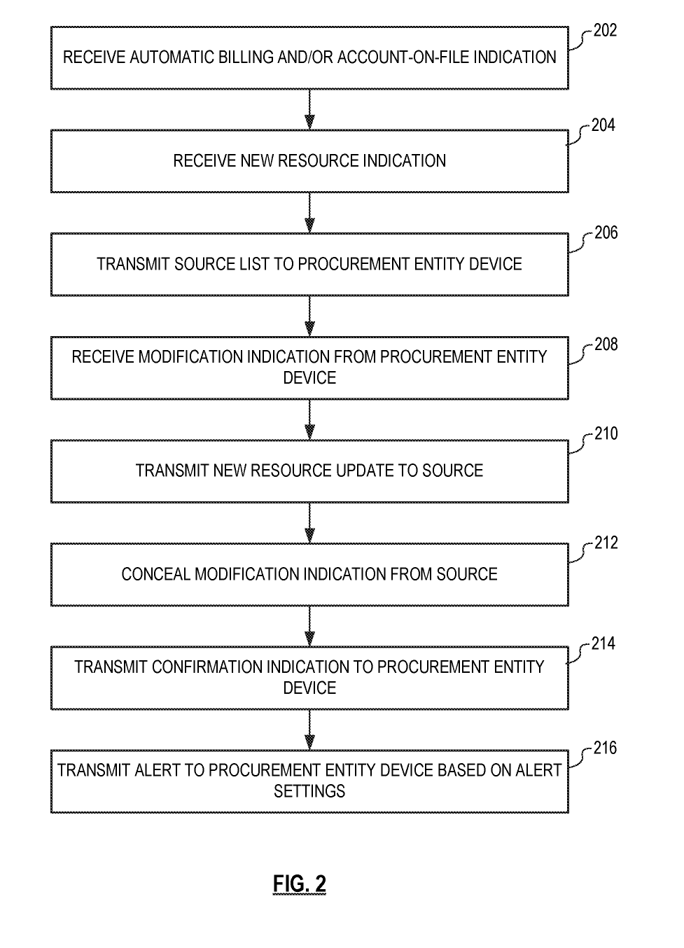

FIG. 2 depicts a method 200 for automatic account-on-file management, in embodiments. It should be appreciated that the order of operations shown in FIG. 2 is not limiting. Method 200 may be implemented via system 100, discussed above, for example within resource provider 108.

In operation 202, an automatic billing and/or account-on-file indication is received. In embodiments of operation 202, source 106 may interact with resource provider 108 to identify automatic payments and/or account-on-file by transmitting the on-file indication 180 to the resource provider 108 including the resource information 122 and billing information 124 for each resource 104 that is set up for automatic remittance and/or account-on-file in association with the given source 106. Account updater 128, in embodiments, may then update billing information 136 based upon billing information 124.

In operation 204, a new resource indication is received. In embodiments of operation 204, one or both of resource provider 108 and resource/account issuer 110 may generate a new resource indication 182 and transmit such indication 182 to procurement entity device 160. New resource indication 182 may include new resource information 152 for storage in memory 168 as new resource information 174. In embodiments, operation 204 may be initiated upon detection of fraudulent activity on the procurement entity's account or resource 104, or that the resource 104 is about to or has expired.

In operation 206, a source list is transmitted to the procurement entity device. In embodiments, operation 206 is initiated in response to procurement entity device 160 transmitting source list request 176 (either automatically in response to a new source indication, or manually upon interaction with the procurement entity). In embodiments, operation 206 is initiated automatically by resource provider 108 and/or resource/account issuer 110 when new resource indication 182 is generated. The source list may include data from billing information 136 identifying which sources 106 include an automatic payment and/or account-on-file setup.

In operation 208, a modification indication is received from a procurement entity device. In embodiments of operation 208, a procurement entity may interact with the procurement entity device to modify the automatic remittance and/or account-on-file status of each source identified in the source list from step 206. Such modification may include any one or more of: updating with the new resource information, cancellation of the automatic remittance information and/or account-on-file status with that given source 106, and configuring an alert for a given source 106. In embodiments, resource/account issuer 110 and/or resource provider 108 may then update billing information 150 and billing information 136, respectively, with the modifications.

In operation 210, a new resource update is transmitted to a source. In embodiments of operation 210, resource provider 108 may transmit new resource information 138 to source 106 as a new resource update 188 and source 106 can replace resource information 122 with new resource information 138 contained within new resource update 188.

In operation 212, modification indication received in step 208 is concealed from a source associated therewith. In embodiments of operation 212, resource provider 108 may not indicate that such modifications to the status of the given source 106 have been made. In other words, the modifications will be concealed to the source 106 such that the source 106 will not know the procurement entity 102 indicated to cancel automatic remittance and/or account-on-file.

In operation 214, a confirmation indication is transmitted to the procurement entity device. In embodiments of operation 214, confirmation indication 190 is sent to procurement entity device 160 from one or both of resource provider 108 and resource/account issuer 110 confirming changes have been made to automatic remittance status and/or account-on-file status for given source(s) 106.

In operation 216, an alert is transmitted to procurement entity device based on alert settings. In embodiments of operation 216, alert setting 192 are configured by procurement entity 102, to indicate when a warning 194 is generated. For example, alert settings 192 may indicate to generate a warning 194 when resource 104 is charged by source 106. As another example, alert settings 192 may indicate to generate a warning 194 when resource 104 is charged by source 106 above a given threshold amount. As another example, alert settings 192 may indicate to generate a warning 194 when resource 104 is charged by source 106 above a given threshold amount and/or at a given time other than an automatic billing period. Alert indication 196, including alert settings 192, may be transmitted from procurement entity device 160 for storage within resource provider 108. As such, any time source 106 requests authorization for a charge on resource 104 that is commensurate with one or more settings within alert settings 192, resource provider 108 may generate a warning indication 198 and transmit such warning indication 198 to procurement entity device 160.

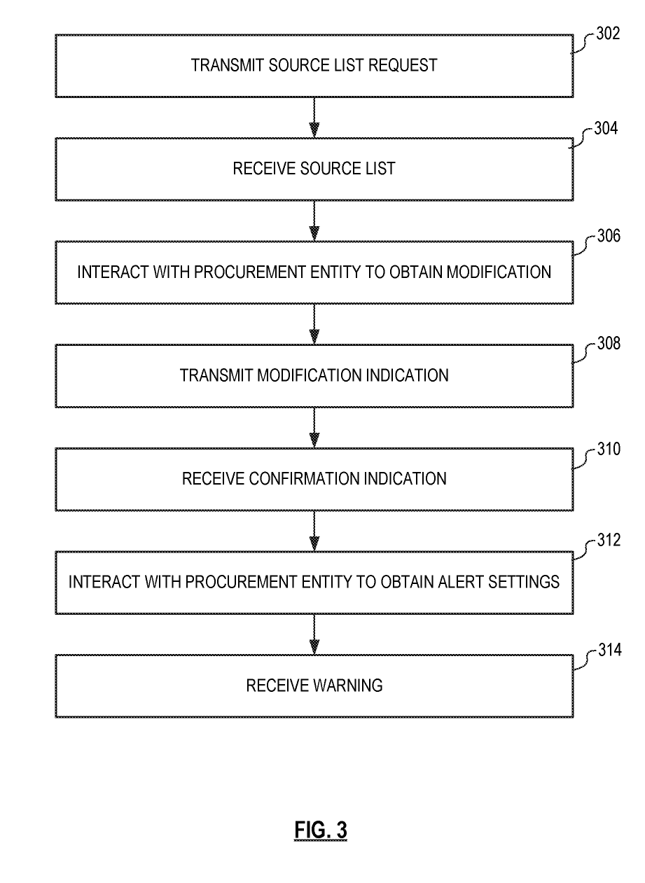

FIG. 3 depicts a method 300 for automatic account-on-file management, in embodiments. It should be appreciated that the order of operations shown in FIG. 3 is not limiting. Method 300 may be implemented via system 100, discussed above, for example within procurement entity device 160. Method 300 may be performed concurrently with method 200.

In operation 302, a source list request is transmitted. In embodiments of operation 302, procurement entity 102, via interaction with resource issuer interface 164 may request a list of all sources 106 with automatic payments and/or account-on-file set up in association with resource 104. In turn, a source list request 176 may be transmitted from procurement entity device 160 to resource provider 108, via resource/account issuer 110.

In operation 304, a source list is received. In embodiments of operation 304, a source list is received from one or more of resource provider 108 and resource/account issuer 110. The source list may include data from billing information 136 identifying which sources 106 include an automatic payment and/or account-on-file setup.

In operation 306, method 300 interacts with the procurement entity to obtain a modification. In embodiments of operation 306, procurement entity device 160, in response to receiving source list in step 304, may generate a prompt 184 to procurement entity 102, within resource issuer interface 164, for a request to update billing information. Prompt 184 may include at least one of: the new resource information 174, a list of all sources 106 within billing information 172 in which the procurement entity 102 has automatic remittance and/or account-on-file with, and charge information (as identified within billing information 172) for each associated source 106. Upon receipt of the prompt, procurement entity 102 may select one or more sources 106 in which the procurement entity 102 has automatic remittance or account-on-file set up with to modify the automatic remittance and/or account-on-file status. Such modification may include any one or more of: updating with the new resource information, cancellation of the automatic remittance information and/or account-on-file status with that given source 106, and configuring an alert for a given source 106 (as discussed below).

In operation 308, a modification indication is transmitted. In embodiments of operation 308, upon receiving such modification from procurement entity 102 interacting with resource issuer interface 164, resource issuer interface 164 may generate a modification indication 186 and transmit said modification indication 186 to resource/account issuer 110, and/or resource provider 108 (via resource/account issuer 110).

In operation 310, a confirmation indication is received. In embodiments of operation 310, confirmation indication 190 may be received at procurement entity device 160 from one or both of resource provider 108 and resource/account issuer 110 confirming changes have been made to automatic remittance status and/or account-on-file status for given source(s) 106. In response to receipt of confirmation indication 190, prompt 184 (or a newly generated additional prompt) may be presented to procurement entity 102 via resource issuer interface 164 confirming changes made to the billing information 172 regarding resource 104.

In operation 312, method 300 interacts with a procurement entity to obtain alert settings. In embodiments of operation 312, procurement entity 102 may interact with resource issuer interface 164 to configure alert settings 192. Alert setting 192 are configured by procurement entity 102, to indicate when a warning 194 is generated. For example, alert settings 192 may indicate to generate a warning 194 when resource 104 is charged by source 106. As another example, alert settings 192 may indicate to generate a warning 194 when resource 104 is charged by source 106 above a given threshold amount. As another example, alert settings 192 may indicate to generate a warning 194 when resource 104 is charged by source 106 above a given threshold amount and/or at a given time other than an automatic billing period.

In operation 314, a warning is received. In embodiments of operation 314, warning 194 is received and presented to procurement entity 102 via resource issuer interface 164. Warning 194 may be an auditory, textual, visual, tactile, or other warning that indicates one or more of alert settings 192 have been met.

The embodiments discussed herein facilitate a procurement entity-controlled solution to enable a seamless process for managing automatic remittance and account-on-file management. These embodiments allow procurement entities to ensure there are no interruptions or unnecessary declines of charges from a source due to outdated resource/account information and give the ability to easily cancel automatic remittance via a procurement entity device. This allows the procurement entity to manipulate billing of multiple sources simultaneously without having to contact each individual source.

It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A system for automatic account-on-file management, comprising:
a resource provider including an account updater and a provider communications interface, the resource provider storing billing information identifying at least one source having an automatic remittance and/or account-on-file for a resource associated with a procurement entity,
the account updater being configured to transmit a source list response indicating each source identified within the billing information,
the provider communications interface configured to transmit the billing information to a procurement entity device for presentation of each source indicated in the source list response to the procurement entity.

2. The system of claim 1, the source list response being generated by the account updater in response to a source list request originating from a resource issuer interface located on a procurement entity device.

3. The system of claim 2, the source list request being generated after a prompt is presented to the procurement entity, via a resource issuer interface on the procurement entity device; the prompt being generated in response to a new resource indication.

4. The system of claim 1, the source list response being generated by the account updater automatically in response to identification of any of: fraudulent activity on the resource, an impending expiration of the resource, an indication that the resource has expired.

5. The system of claim 1, the source list response being generated in response to a new resource indication generated by one or both of the resource provider and a resource/account issuer.

6. The system of claim 1, the account updater configured to receive, from a procurement entity device, a modification to the billing information identified in the source list.

7. The system of claim 6, the modification including one or more of an update of new resource information with at least one source, cancellation of the automatic remittance information and/or account-on-file with at least one source, and an alert for at least one source.

8. The system of claim 6, the account updater configured to transmit the modification to each source associated with the modification.

9. The system of claim 6, the account updater configured to conceal the modification from at least one source associated with the modification.

10. A method for automatic account-on-file management, comprising:
maintaining a source list identifying billing information associated with at least one source having an automatic remittance and/or account-on-file for a resource associated with a procurement entity;
transmitting the source list to a procurement entity device for presentation on the procurement entity device of each source indicated in the source list.

11. The method of claim 10, the step of transmitting occurring in response to a new resource indication.

12. The method of claim 11, the new resource indication being generated in response to identification of any of: fraudulent activity on the resource, an impending expiration of the resource, an indication that the resource has expired.

13. The method of claim 10, further comprising receiving a modification to the source list from the procurement entity device.

14. The method of claim 13, the modification including one or more of an update of new resource information with at least one source, cancellation of the automatic remittance information and/or account-on-file with at least one source, and an alert for at least one source.

15. The method of claim 13, further comprising transmitting the modification to a source associated with the modification.

16. The method of claim 13, further comprising concealing the modification from a source associated with the modification.

17. A method for automatic account-on-file management, comprising:
receiving a source list at a procurement entity device, the source list identifying billing information associated with at least one source having an automatic remittance and/or account-on-file for a resource associated with a procurement entity;
interacting with a procurement entity via the procurement entity device to receive a modification to the source list;
transmitting a modification indication including the modifications to an account manager.

18. The method of claim 17, further comprising generating a warning at the procurement entity device that an alert setting has been triggered.

19. The method of claim 18, the alert setting indicating the resource has been charged by the source, the resource has been charged by the source above a given threshold, and/or the resource has been charged by the source outside of an automatic billing period.

20. The method of claim 17, the modification including one or more of an update of new resource information with at least one source, cancellation of the automatic remittance information and/or account-on-file with at least one source, and an alert for at least one source.
